(19) United States
(12) Patent Application Publication
(10) Pub. No.: US 2026/0323167 A1
(43) Pub. Date: Oct. 15, 2026

(54) SYSTEM AND METHOD FOR BEACONLESS ADAPTIVE OPTICS BY MEANS OF A MULTI-PLANE SENSOR AND CONVOLUTIONAL NEURAL NETWORK

(71) Applicant: The Government of the United States of America, as represented by the Secretary of the Navy, Arlington, VA (US)

(72) Inventors: Gregory P. DiComo, Silver Spring, MD (US); George A. Witt, Stanford, CA (US)

(73) Assignee: The Government of the United States of America, as represented by the Secretary of the Navy, Arlington, VA (US)

(21) Appl. No.: 19/545,222

(22) Filed: Feb. 20, 2026

Related U.S. Application Data
(60) Provisional application No. 63/760,773, filed on Feb. 20, 2025.

(51) Int. Cl. H04N 23/90; G01S 13/08; G01S 17/08; G02B 27/00; G02B 27/28; H04N 23/69

(52) U.S. Cl. CPC H04N 23/90; G01S 13/08; G01S 17/08; H04N 23/69; G02B 27/0025; G02B 27/283

(57) ABSTRACT

An apparatus includes a laser emitting laser light. The apparatus includes a wavefront corrector. The wavefront corrector directs the laser light through a distorting optical medium to a scattering object. The scattering object scatters the distorted light from the distorted spot back through the distorting optical medium to impinge upon the wavefront corrector. The apparatus includes a plurality of imaging cameras including a focal plane camera and at least one of a post-focus camera and a pre-focus camera. The imaging cameras receives the scattered light from the distorted spot via the wavefront corrector. The imaging cameras generates image data. The apparatus includes a convolutional neural network receiving at least the image data. The convolutional neural network outputs control data to the wavefront corrector based in part on the image data. The control data adjusts the wavefront corrector to correct for distortions imposed by the distorting optical medium.

### CROSS-REFERENCE TO RELATED APPLICATIONS

This Application is a Non-provisional of, and claims the benefit of priority under 35 U.S.C. § 119 based on, U.S. Provisional Patent Application No. 63/760,773 filed 20 Feb. 2025. The Provisional Application and all references cited herein are hereby incorporated by reference into the present disclosure in their entirety.

### FEDERALLY SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; techtran@nrl.navy.mil, referencing Navy Case No. 212,355-US2.

### BACKGROUND OF THE INVENTION

### Field of the Invention

Aspects of the present invention relate generally to an apparatus and/or method for atmospheric imaging and optical beam propagation and, more particularly, to an apparatus and/or method for mitigating effects of atmospheric optical turbulence on laser propagation and optical imaging using a multi-plane sensor and/or a convolutional neural network.

### Description of the Related Art

Lasers are devices which emit coherent light based on the physical process of stimulated emission of radiation. Lasers commonly in use today fall broadly into two classes: continuous-wave lasers, which continuously generate a beam of light with power which is constant or slowly-varying in time; and pulsed lasers, which generate one or more discrete pulses of light, either on-demand or automatically repeating. Any light from a continuous-wave laser, or any pulse or plurality of pulses from a pulsed laser, is known as a “laser beam.”

Light propagates as a series of electromagnetic waves. The phase relationship between these waves determines the propagation direction, spreading, and many other properties of the light. As the waves propagate through a medium, the collection of points with the same phase can be visualized as a wavefront. In the optics context, terms such as “wavefront,” “phase,” and “transverse phase” can be used interchangeably.

An optical medium is a physical substance through which light can propagate, such as air, glass, water, or plasma. Any composition of multiple optical media and/or the interfaces between said optical media may be considered in itself to be an optical medium. An optical medium can be characterized by its refractive index, which may be uniform, nonuniform, time-varying, polarization-dependent, or any number of other properties.

Optical distortion is any deviation in the wavefront of a laser beam or other light field from that which is expected or desired.

Optical distortion can occur due to multiple mechanisms, including turbulence within an optical medium, a structured non-uniform refractive index within an optical medium, or a structured non-uniform refractive interface between optical media. For example, turbulence causes spatio-temporal variation in the refractive index of a physical medium, such as air, water, or other fluids. This variation causes distortions in the wavefront of any light that propagates through that medium, resulting in, among other effects, aberrations of images taken over a long distance, as well as excess spreading and wander of laser beams.

Other examples of optical distortions which are not due to turbulence are the structured refractive interface between air and water (due to wave action), the structured refractive index of a damaged or distorted optical element such as a mirror or lens, and the structured refractive index of the cornea, lens, and vitreous humor within the eye.

Adaptive Optics (“AO”) is a collection of techniques, methods, and machines intended to reduce the effects of optical distortion on light as it propagates through optical media. The core method of AO is the adjustment of the phase of the light in question by one or more phase-adjusting devices such as deformable mirrors, spatial light modulators (“SLM”), or any other similar device. The phase-adjusting element changes the wavefront of the light in order to remove or mitigate the optical distortion. For this reason, for the purpose of this patent application, such a phase-adjusting device or set of devices is generally described as a wavefront corrector (“WFC”).

A conventional geometry for an AO System designed to correct optical distortions due to turbulence consists of a “local” platform on which the AO System is mounted; an open volume of optical medium (such as air, water, or some other gas or fluid) in which turbulence generates optical distortions; and a plane containing some object or objects of interest, the “object plane.”

In the case of imaging an object through turbulence, the WFC must remove the distortions imposed by turbulence. In the case of propagating a laser beam through turbulence, the WFC must pre-compensate the laser wavefront with distortions equal and opposite to those that the turbulence will impose on the beam as it propagates. Turbulence then acts to remove the pre-applied distortions, resulting in an undistorted beam at the end of propagation. Often, the goal is to produce a laser spot in the object plane, which is as small as possible. In the context of AO, a laser spot or other object is said to be “small” when it is comparable to or smaller than the laser spot which would be produced by a diffraction-limited Gaussian laser beam, propagating the same distance through the same optics, in the absence of turbulence. There are multiple ways of determining the correct adjustment for the WFC to perform in order to correct for the action of turbulence. Many AO systems use some method to measure the distortions caused by the turbulence, and compute the correct WFC adjustment from that information.

One common method for sensing turbulence-induced phase distortions uses a wavefront sensor (“WFS”) and a beacon or guide star, such as shown in FIG. 1. A remote beacon, also known as a guide star, is a small light source located near the object of interest, that aids in measuring the wavefront distortion caused by turbulence. Because the beacon can be approximated as a point source, the beacon light which reaches the AO system would be expected have a spherical phase front with radius of curvature equal to the distance between the AO system and the object plane. Any deviation from this phase front can be attributed to the intervening optical medium.

Often, a naturally-occurring beacon on or near the object plane is not available. In this case, a dedicated laser within the AO system might emit a beam which propagates from the location of the AO system towards the object plane. This beam can generate a beacon spot by reflecting or scattering from the object, by exciting fluorescence or generating emissive plasma in the object plane, or by some other mechanism. A laser adapted for use in this role is termed a beacon laser. The light emitted by the beacon propagates from the object plane, through turbulence, to the local platform. There, the wavefront of the light is sensed by a WFS. In operation, a track camera, not shown in FIG. 1, observes a distant scattering object. The steering mirror tilts to center the object. The beacon laser creates a beacon spot on the scattering object. Scattered light from the beacon spot returns to the apparatus, encoding turbulent phase distortions. The phase distortions are sensed by a wavefront sensor, which sends wavefront data representing those distortions to a processor. The processor generates an equal and opposite phase distortion to the phase distortions sensed by the wavefront sensor. The processor generates control data for a deformable mirror to generate the equal and opposite phase distortion on the beacon laser's light. In subsequent use, in theory, the wavefront sensor observes a less-distorted wavefront, and the effects laser focuses to a smaller spot on the distant object.

This prior art approach is unattractive to practitioners for at least two reasons. First, the beacon argument is circular. If a small laser spot can be projected onto the distant object to serve as a beacon, then a small laser spot can be projected onto the distant object for any other application, such as laser-induced breakdown spectroscopy, directed energy, or laser scanning. Further, due to the principle of reciprocity, if a small laser spot can be projected onto an object, then a clear image can be formed of that object by an imaging camera co-located with the laser. Second, wavefront sensing in practice is hard. For example, a conventional, Shack-Hartmann WFS performs poorly in the presence of strong turbulence. As another example, a conventional, digital holography WFS requires a complicated and expensive beacon laser having a long coherence length and very sensitive alignment.

Other prior art AO systems, hoping to avoid the additional complexity of a beacon laser, perform random or semi-random variations on the WFC and observe the result, expecting though not successfully achieving improvement with each variation. This second class of AO systems is, for example, referred to as “variational,” “iterative,” or “hill-climbing” AO systems. Iterative AO systems are generally too slow for use in dynamic atmospheric turbulence. On the order of hundreds to thousands of iterations may be required to obtain one wavefront correction; for details, see VORONTSOV, M. A., et al., “Stochastic parallel-gradient-descent technique for high-resolution wave-front phase-distortion correction,” J. Opt. Soc. Am. A, October 1998, pp. 2745-2758, Vol. 15, No. 10, Optical Society of America, Washington, DC, USA, incorporated by reference. By comparison, the typical frequency with which atmospheric turbulence varies is given by the Greenwood frequency, on the order of 100 Hz, and it is desirable to perform corrections on the order of 10 times this frequency; for details see TYLER, G. A., “Bandwidth considerations for tracking through turbulence,” J. Opt. Soc. Am. A, January 1994, pp. 358-367, Vol. 11, No. 1, Optical Society of America, Washington, DC, USA, as well as TYSON, R. K., et al, “Field Guide to Adaptive Optics, Second Edition,” 2012, SPIE Press, Bellingham, WA, USA, both incorporated by reference. Iterative techniques therefore require the entire system of high-resolution camera, computer, and associated hardware and software to operate at a rate comparable to (100 iterations)×(100 Hz)×(10)=100 kHz. In practice, this rate is unattainable.

Certain other prior art AO systems and techniques might be mistaken for the present invention upon a cursory reading; however, one of ordinary skill in the art will readily appreciate the significant differences and advantages of the present invention. The “Fresnel Wavefront Sensor” uses a plurality of imaging cameras located in multiple imaging planes to detect the wavefront of beacon light entering an AO system. This differs from the present invention in several ways. First, the several imaging cameras are located at and near the pupil plane, rather than the focal plane. Locating the imaging cameras near the focal plane, as in the present invention, has the benefit of producing a crisp image of the laser spot on the scattering object in the process of performing the correction, rather than requiring an additional detector. Second, the algorithm used to extract useful wavefront data from the Fresnel WFS is the Modified Gerchberg-Saxton algorithm, rather than a convolutional neural network (“CNN”), as used in the present invention. The Modified Gerchberg-Saxton algorithm is an iterative technique which, although it does not require physical variation of the WFC, requires many sequential computational passes through a computer simulation, iteratively refining its estimate of the wavefront until convergence. A feed-forward CNN, as used in the present invention, requires only a single forward pass through a highly parallel neural network. Third, the Fresnel WFS is a device which actually senses the wavefront of the input light which falls on the several detectors. Therefore, employment of the Fresnel WFS requires a beacon. It is essentially an alternative to conventional Shack-Hartmann or digital holography-based wavefront sensors. For details, see CREPP, J. R., et al., “Measuring phase errors in the presence of scintillation,” Optics Express, 7 Dec. 2020, pp. 37721-37733, Vol. 28, No. 25, Optica Publishing Group, Washington, DC, USA, which is incorporated herein by reference.

Sandler et al have published a technique which uses an imaging camera to record in-focus and out-of-focus images of starlight entering an astronomical telescope equipped with an AO system, and uses a fully-connected neural network (also known as a multi-layer perceptron) to estimate the wavefront of that light. This differs from the present invention in several ways. First, the algorithm used to extract useful data from the images is a multi-layer perceptron, rather than a CNN as used in the present invention. One of ordinary skill in the art will recognize that the CNN architecture is superior to the multi-layer perceptron for image processing applications: for instance, it requires vastly fewer weights to handle images of a given size, avoids vanishing and exploding gradients during training, and implicitly respects the feature locality which is typical of image data. Second, Sandler's technique estimates the wavefront of the input light, and therefore requires a convenient point-like “reference star” near the object of interest, or else a “laser guide star,” or beacon. It is essentially an alternative to conventional Shack-Hartmann or digital holography-based wavefront sensors. For details, see SANDLER, D. G., et al., “Use of a neural network to control an adaptive optics system for an astronomical telescope,” Nature, 23 May 1991, pp. 300-302, Vol. 351, No. 6324, Nature Publishing Group, London, United Kingdom, which is incorporated herein by reference.

Fu et al have published a technique which uses a single imaging camera to record images of laser light entering an AO system, and uses a CNN to estimate the wavefront of that light and perform a correction using a WFC. This has several defects. First, mathematical symmetries ensure that it is not possible, even in principle, to determine accurately the wavefront of light based on a single image plane so long as the pupil remains circular: for details, see SIDDIK, A. B., et al., “Deep learning estimation of modified Zernike coefficients and recovery of point spread functions in turbulence,” Optics Express, 23 Jun. 2023, pp. 22903-22913, Vol. 31, No. 14, Optica Publishing Group, Washington, DC, USA, which is incorporated herein by reference. Second, the technique uses a cooperative laser. For the purpose of this patent application, “cooperative laser,” “cooperative beacon,” “guide-star,” and similar terms are terms of art which refer to an optically-small (diffraction-limited or smaller) light source which is located at or near the remote object, rather than mounted on the same platform as the AO system. Fu's device is therefore a two-ended device appropriate for use in optical communications, rather than a single-ended device for imaging or laser propagation, like the present invention. Third, if it were to be adapted to a single-ended configuration, Fu's technique would estimate the wavefront of the input light which falls on the detector, and therefore requires a beacon. It is essentially an alternative to conventional Shack-Hartmann or digital holography-based wavefront sensors, with the caveat that the device cannot possibly function as intended. For details, see FU, H-B, et al., “Experimental demonstration of deep-learning-enabled adaptive optics,” Phys. Rev. Appl., 19 Sep. 2024, pp. 034047, Vol. 22, American Physical Society, College Park, MD, USA, which is incorporated herein by reference.

One of ordinary skill in the art will readily appreciate that the apparatus herein described is not a wavefront sensor, does not perform wavefront sensing, and thereby differs fundamentally from other apparatuses and methods in the prior art. Instead, the present invention associates multiple images of a turbulence-distorted laser spot on a remote scattering object (those images themselves being distorted by the action of turbulence), with a wavefront correction which compensates for the distorting effects of turbulence. The relationship between the observed images and the desired wavefront correction is learned by the CNN during training, encoded within the CNN's weights and biases, and can thereafter be used to produce new wavefront corrections in response to new images. This adjustment does not represent the wavefront of the light which formed those images, or indeed the wavefront of any light which is physically present at the time of operation. Rather, it represents a desired wavefront correction which results in improved laser propagation and/or improved imaging of the scattering object and/or improved figure of merit on the scattering object. This is distinct from, and superior to, systems and methods which sense or estimate the wavefront of the light which forms the image or images, because that light is subject to various nonidealities. For instance, in the presence of a distorting optical medium, the light produced by a beacon laser forms an extended spot which does not meet the criteria for a small beacon spot; the wavefront measurement will therefore be corrupted by anisoplanatism error. Additionally, the wavefront of that light will be corrupted by the shape and roughness of the scattering object. Sensing and correcting for the wavefront distortions due to the shape and roughness of the scattering object is not desirable, and does not result in the best laser propagation and/or imaging of the scattering object and/or figure of merit on the scattering object. Only those wavefront distortions which arise due to the distorting optical medium are to be corrected. Therefore, a correction equal and opposite to the wavefront of the light scattered from the beacon spot is not actually the desired correction. Only in the case where a small light source, free of substantial phase noise due to roughness, is present near the object of interest will wavefront sensing approaches produce the desired correction.

### SUMMARY OF THE INVENTION

An embodiment of the invention includes a machine-learning apparatus and/or machine learning method to emulate the action of adaptive optics for atmospheric laser propagation in the absence of a dedicated beacon laser. That is, this embodiment of the invention is free of a beacon light source local to the AO system, such as a beacon laser, and does not require the presence of an optically-small light source near the object plane, such as a guide-star or cooperative beacon. The apparatus and/or method measures scattered-light fluence profiles recorded in image planes nearly conjugate to the object plane, and uses a convolutional neural network to correlate those images to a phase profile, which produces an improved figure of merit and/or improved imaging of the remote scattering object.

In an embodiment of the invention, the figure of merit which is improved is one or more of the Power-in-the-Bucket, Normalized Power-in-the-Bucket, Strehl, Strehl-in-the-Bucket, and/or FOM, as defined in the following equations:

$$Power - in - the - Bucket {(}^{‶} {PIB}^{″} ) = \frac{energy inside bucket}{total energy} .$$

$$Normalized Power - in - the - Bucket {(}^{‶} {nPIB}^{″} ) = \frac{PIB}{{PIB}_{vac}} .$$

$$Strehl = \frac{peak intensity}{peak intensity in vacuum} .$$

$$Strehl \text{-in-the-Bucket} {(}^{‶} {SIB}^{″} ) = \frac{peak intensity in bucket}{peak intensity in bucket in vacuum} .$$

$$Figure of Merit {(}^{‶} {FOM}^{″} ) = \sqrt{nPIB * SIB} .$$

This figure of merit is agnostic to relative importance of peak versus average intensity. This figure of merit prevents gaming the system by penalizing high-intensity, off-target laser beams and by preferring intense beams over diffuse beams for a fixed PIB. This figure of merit saturates near 1 for linear beams for standard high energy lasers and standard pulsed laser systems. This figure of merit supports values greater than 1 for extension to nonlinear beams, such as used in standard high power, laser systems.

An embodiment of the invention includes an adaptive optics system that uses a multi-plane sensor and convolutional neural network (“CNN”) to correct for optical distortions produced by turbulence.

An embodiment of the invention includes a method for training the CNN so that it will perform the desired corrections. This embodiment of the invention enables better imaging and laser beam propagation in conditions of atmospheric turbulence.

An embodiment of the invention includes an AO system having two or more sensors, one or more WFC elements, and a CNN that adjusts the WFC in accordance with the signal detected on the sensors.

An embodiment of the invention finds application in laser-based directed energy systems, optical communications, laser-based power beaming, long-range imaging (e.g., surveillance, reconnaissance, television broadcasting and infrastructure inspection), and optical remote sensing (e.g., Laser-Induced Breakdown Spectroscopy, geological surveys, and mapping).

An embodiment of the invention includes an apparatus. The apparatus includes a laser emitting laser light. The apparatus includes a wavefront corrector. The wavefront corrector directs the laser light through a distorting optical medium to a scattering object. The distorted light forms a distorted spot on the scattering object. The scattering object scatters the distorted light from the distorted spot back through the distorting optical medium. The scattered light from the distorted spot impinges upon the wavefront corrector. The apparatus includes a plurality of imaging cameras including a focal plane camera and at least one of a post-focus camera and a pre-focus camera. The plurality of imaging cameras receives the scattered light from the distorted spot via the wavefront corrector. The plurality of imaging cameras generates image data. The apparatus includes a convolutional neural network receiving at least the image data. The convolutional neural network outputs control data to the wavefront corrector based in part on the image data. The control data adjusts the wavefront corrector to correct for distortions imposed by the distorting optical medium.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 is a block diagram of a prior art apparatus.

FIG. 2 is a block diagram of an embodiment of the invention.

FIG. 3 is a block diagram of imaging cameras, according to an embodiment of the invention.

FIG. 4A is a block diagram of an optical switch, according to an embodiment of the invention.

FIG. 4B is a block diagram of an optical switch, according to an embodiment of the invention.

FIG. 4C is a block diagram of an optical switch, according to an embodiment of the invention.

FIG. 4D is a block diagram of an optical switch, according to an embodiment of the invention.

FIG. 4E is a block diagram of an optical switch, according to an embodiment of the invention.

FIG. 4F is a block diagram of an optical switch, according to an embodiment of the invention.

FIG. 5A is a block diagram of a range estimator, according to an embodiment of the invention.

FIG. 5B is a block diagram of a range estimator, according to an embodiment of the invention.

FIG. 5C is a block diagram of a range estimator, according to an embodiment of the invention.

FIG. 6A is a block diagram of a beam director, according to an embodiment of the invention.

FIG. 6B is a block diagram of a beam director, according to an embodiment of the invention.

FIG. 7A is a block diagram of a coherence length estimator, according to an embodiment of the invention.

FIG. 7B is a block diagram of a coherence length estimator, according to an embodiment of the invention.

FIG. 7C is a block diagram of a coherence length estimator, according to an embodiment of the invention.

FIG. 7D is a block diagram of a coherence length estimator, according to an embodiment of the invention.

FIG. 7E is a block diagram of a coherence length estimator, according to an embodiment of the invention.

FIG. 7F is a block diagram of a coherence length estimator, according to an embodiment of the invention.

FIG. 8 is a block diagram of a zoom lens according an embodiment of the invention.

FIG. 9 is a block diagram of a dichroic mirror cooperating with an optical switch and a lens according an embodiment of the invention.

FIG. 10 is a block diagram of beam reflectors optically cooperating with respective imaging cameras, according to an embodiment of the invention.

FIG. 11 is a block diagram of beam reflectors optically cooperating with respective imaging cameras via respective lenses, according to an embodiment of the invention.

FIG. 12 is a block diagram of a training data structure for a convolutional neural network, according to an embodiment of the invention.

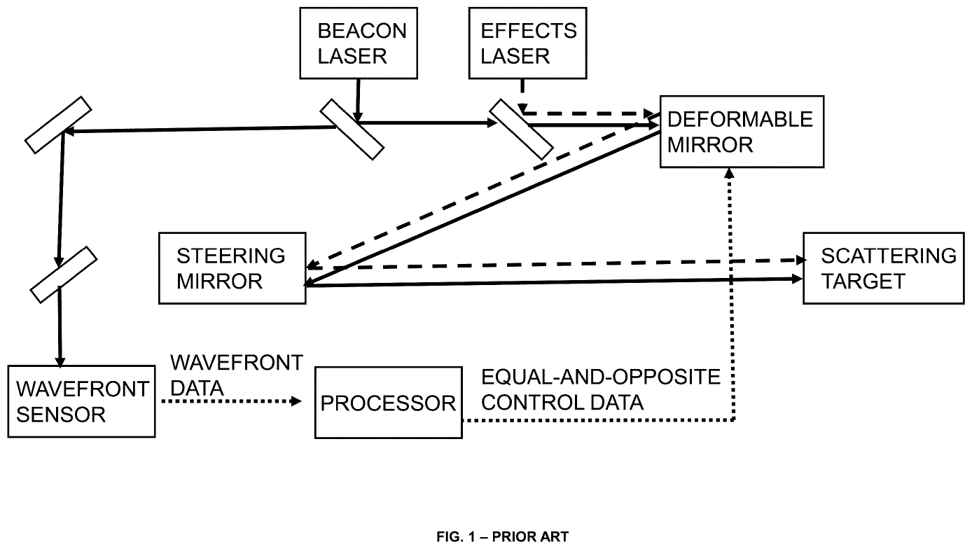

### DETAILED DESCRIPTION

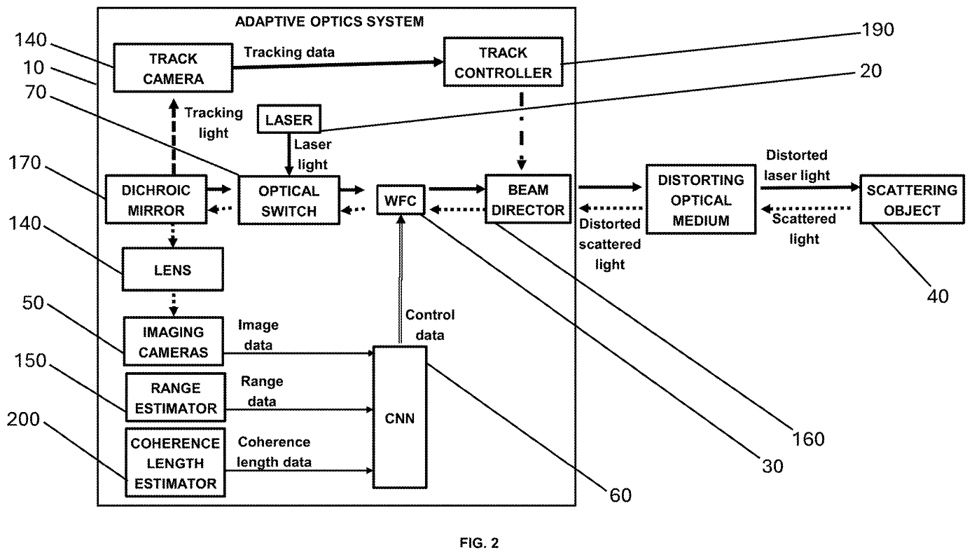

An embodiment of the invention includes an AO apparatus 10 for mitigating effects of atmospheric optical turbulence on laser propagation and optical imaging, is described as follows, and is shown by way of illustration in FIG. 2. The AO apparatus 10 includes a standard laser 20 emitting laser light. The apparatus 10 includes a standard wavefront corrector 30. The wavefront corrector (“WFC”) 30 directs the laser light through a distorting optical medium to a scattering object 40. For the purpose of this patent application, “wavefront corrector” is a term of art and means an optical, opto-mechanical, opto-electronic, opto-acoustic, or other device whose purpose is to intentionally and dynamically adjust the wavefront of a laser beam or other light field according to a user's command. In an embodiment of the invention, the distorting optical medium includes an atmosphere that exhibits atmospheric optical turbulence. In another embodiment of the invention, the distorting optical medium includes freshwater or saltwater that exhibits optical turbulence. The laser light is distorted by its passage through the distorting optical medium. The distorted laser light forms a distorted spot on the scattering object 40. The scattering object 40 scatters the light from the distorted spot back through the distorting optical medium. The scattered light from the distorted spot is itself distorted by its passage through the distorting optical medium. The distorted scattered light impinges upon the wavefront corrector 30. In an embodiment of the invention, the WFC 30 includes a standard deformable mirror and/or a standard spatial light modulator.

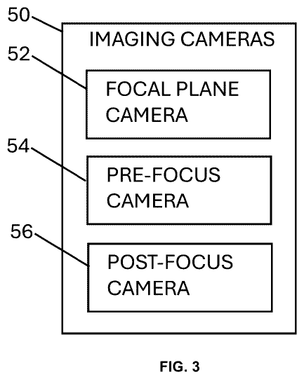

The apparatus 10 includes a plurality of standard imaging cameras 50 comprising a focal plane camera 52 and at least one of a pre-focus camera 54 and a post-focus camera 56, as shown by way of illustration in FIG. 3. For the purpose of this patent application, “focal plane camera” is a term of art and means a digital or electronic camera having its light-sensitive element located at or very near the focal plane of an imaging lens, in such a way that an optical image of the object plane appears on the camera's light-sensitive element. In the absence of turbulence, this optical image will include a clear, focused image of the laser beam as it impinges on the scattering object. In the presence of turbulence, this optical image will comprise an image of the turbulence-distorted laser beam as it impinges on the scattering object, such image itself distorted by the propagation of the scattered light back through turbulence. For the purpose of this patent application, “pre-focus camera” is a term of art and means a digital or electronic camera having its light-sensitive element located in a plane that is in front of (or before) the focal plane of an imaging lens. For the purpose of this patent application, “post-focus camera” is a term of art and means a digital or electronic camera having its light-sensitive element located in a plane that is in front of (or before) the focal plane of an imaging lens. The plurality of imaging cameras receives the scattered light from the distorted spot via the wavefront corrector 30. The plurality of imaging cameras 50 generates image data.

The apparatus 10 includes a convolutional neural network (“CNN”) 60 receiving at least the image data, as shown by way of illustration in FIG. 2. For the purpose of this patent application, “convolutional neural network” is a term of art and means a feedforward neural network comprising convolutional layers (e.g., for feature extraction), pooling layers (e.g., for downsampling), and finally, one or more fully connected (sometimes called dense) layers, these fully connected layers together comprising at least one multilayer perceptron (“MLP”), for prediction of features of the output based on extracted features from the input. In an embodiment of the invention, the at least one MLP includes a standard Rectified Linear Unit (“ReLU”) activation function in its hidden layers. One of ordinary skill in the art will readily appreciate alternative, standard nonlinear activation functions, such as Softplus, Sigmoid Linear Unit (“SiLU” or “swish”), or Exponential Linear Unit (“ELU”), that are used in place of the ReLU activation function in alternative embodiments of the invention, depending on the user's application. One of ordinary skill in the art will readily appreciate that regularization techniques such as dropout, weight decay, and pruning, which may set the weight of some connections within the MLP to zero, may be applied without fundamentally altering the nature of the MLP or the CNN. The convolutional neural network 60 is trained to adjust the wavefront corrector according to respective distortions imposed by the distorting optical medium so that the apparatus is free of a beacon laser and/or an effects laser as is or are required in conventional adaptive optics systems. The convolutional neural network 60 outputs control data to the wavefront corrector 30 based in part on the image data.

In an embodiment of the invention, the control data includes represents a phase (or an adjustment to a phase or a correction to a phase) for the WFC 30. In another embodiment of the invention, the control data includes Zernike mode amplitudes. In another embodiment of the invention, the control data includes a plurality of deformable mirror actuator offsets. For the purpose of this patent application, “deformable mirror” (“DM”) is a term of art and means a mirror whose physical surface may be intentionally and dynamically deformed from flat according to the user's command. The deformations applied to the DM's surface are transferred to the wavefront of any laser beam or other light field which reflects off of the mirror's surface according to the equation

$${ϕ}_{r} = {ϕ}_{0} + 2 \frac{2 π}{λ} {d}_{DM} ,$$

where φᵣ is the two-dimensional phase profile of the laser (measured in radians) after reflection by the DM, φ₀ is the initial two-dimensional phase profile of the laser before reflection by the DM, λ is the central wavelength of the laser (measured in nanometers), and d_{PM} is the physical offset of the DM's deformed surface from a flat plane (measured in nanometers). In an embodiment of the invention, the deformable mirror includes actuators that push and/or pull the mirror's surface shape to correct light wavefront distortions so as to shape laser beams reflected from the mirror. In an embodiment of the invention, the motion of the actuators on the deformable mirror is determined by a control interface, comprising at least one of a control electronics, a control software, and a control driver. In an embodiment of the invention, the control interface accepts input in the form of Zernike mode amplitudes, and thereafter uses standard mathematical Zernike polynomials to define the surface shape of the deformable mirror. These deformable mirrors are, for example, built with standard piezoelectrics or standard micro-electro-mechanical systems (“MEMS”). In another embodiment of the invention, the control data includes standard units, such as radians, waves, or volts appropriate to control the WFC 30. The control data adjusts the WFC 30 to correct for distortions imposed by the distorting optical medium. This results in an improved laser spot on the scattering object 40, improved imaging of the laser spot on the focal plane camera 52, and improved imaging of the scattering object 40 on the track camera 140.

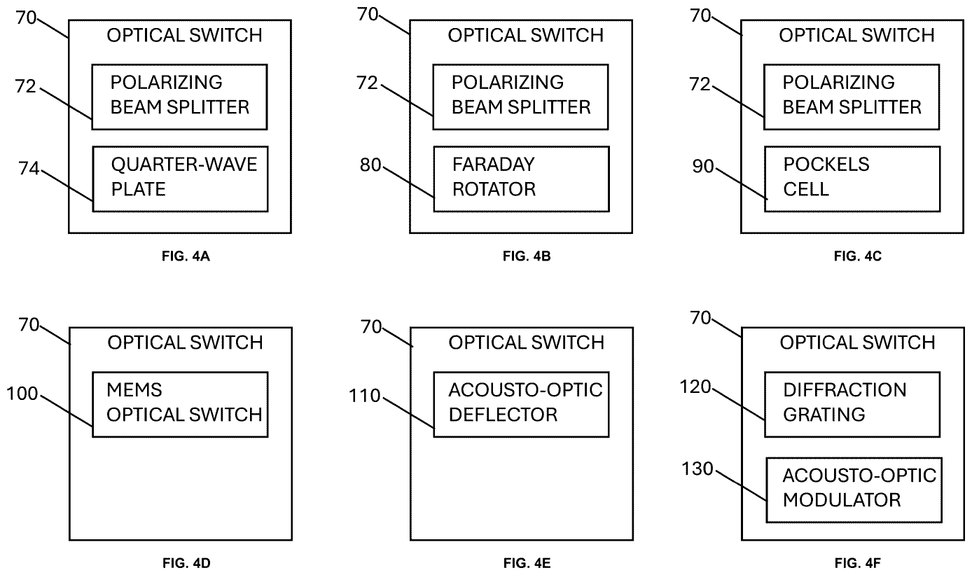

Optionally, the apparatus 10 further includes a standard optical switch 70 directing the laser light to the wavefront corrector 30, as shown by way of illustration in FIG. 2. Optionally, the optical switch 70 includes a standard polarizing beam splitter 72 and a standard quarter-wave plate 74 optically cooperating with the polarizing beam splitter, a standard Faraday rotator 80 optically cooperating with the polarizing beam splitter 22, and/or a standard Pockels cell 90 optically cooperating with the polarizing beam splitter 72, as shown by way of illustration in FIG. 4A-4C. Optionally, the optical switch 70 includes a standard MEMS optical switch 100, as shown by way of illustration in FIG. 4D. Optionally, the optical switch 70 includes a standard acousto-optic deflector 110, as shown by way of illustration in FIG. 4E. Optionally, the optical switch 70 includes a standard diffraction grating 120 and an acousto-optic modulator 130 optically cooperating with the diffraction grating, as shown by way of illustration in FIG. 4F.

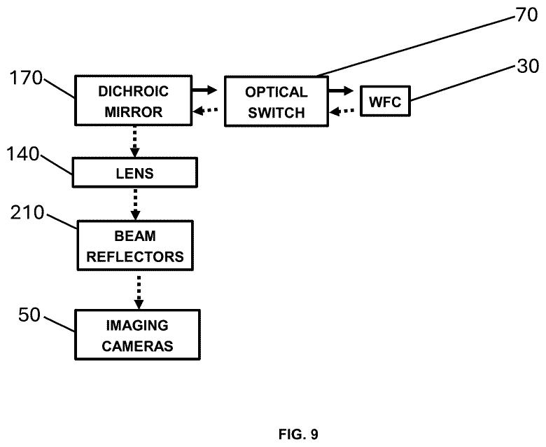

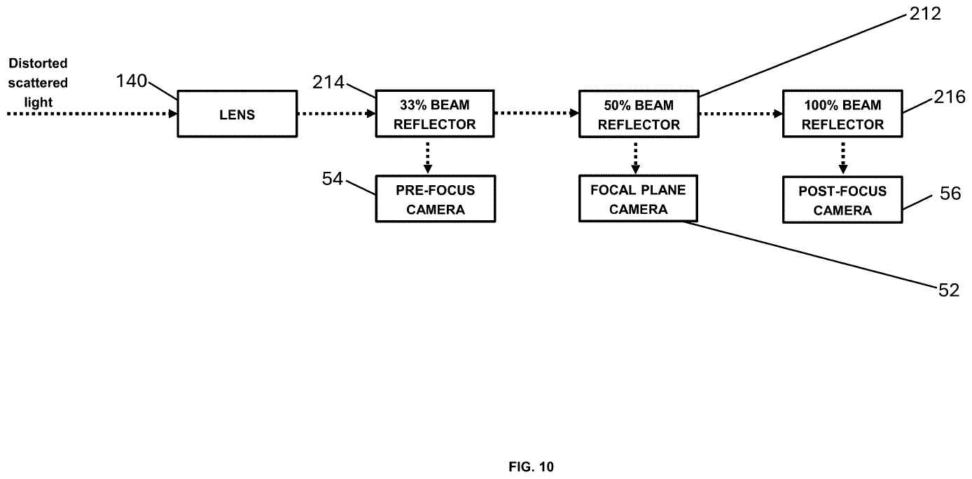

Optionally, the apparatus 10 further includes a standard lens 140 optically cooperating with the plurality of imaging cameras 50, as shown by way of illustration in FIG. 2. The wavefront corrector 30 directs the scattered light from the distorted spot to the lens 140. The lens 140 focuses the scattered light from the distorted spot onto the plurality of imaging cameras 50. In an embodiment of the invention, light going to the lens 140 then goes through a plurality of standard beam reflectors 210, the plurality of beam reflectors 210 respectively corresponding to the plurality of cameras, such as shown by way of illustration in FIG. 9 and FIG. 10. In such an embodiment of the invention, the beam reflectors 210 are selected so as to avoid introducing astigmatism.

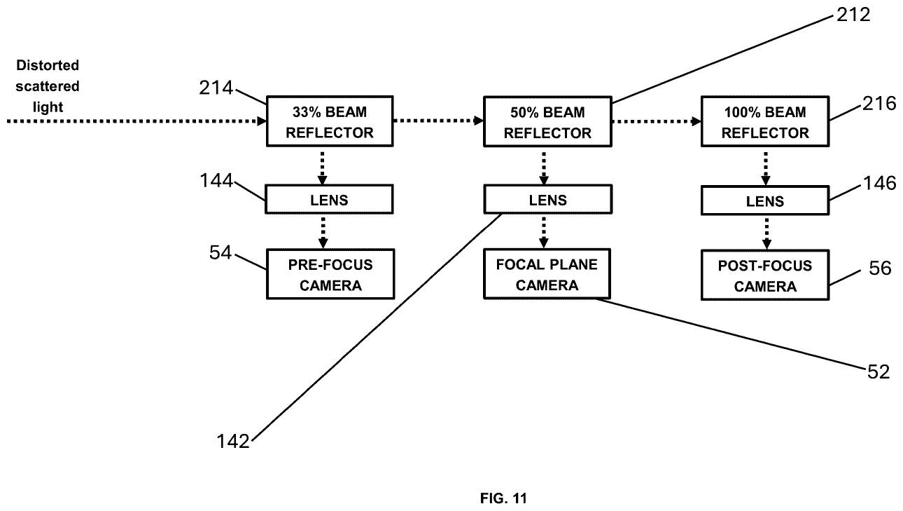

In another embodiment of the invention, the lens 140 includes a plurality of lenses respectively corresponding to the plurality of cameras, such as shown by way of illustration in FIG. 11. In this embodiment of the invention, light goes through a plurality of standard beam splitters and then goes through the lens 140, the plurality of beam splitters respectively corresponding to the plurality of lenses, which in turn respectively correspond to the plurality of cameras.

Optionally, in an embodiment of the invention, the lens 140 comprises a focal plane and a focal length. In this embodiment of the invention, the focal plane camera 52 is located at the focal plane of the lens, and the pre-focus camera 54 and/or the post-focus camera 56 is located a distance from the focal plane of the lens 140, the distance being half the focal length of the lens. In embodiments of the invention where lens 140 comprises a plurality of lenses, the focal lengths of the several lenses may be the same or different from one another. In these embodiments, the distance from the focal plane for the pre-focus camera 54 and/or the post-focus camera 56 is half the focal length of the lens respectively corresponding to that camera.

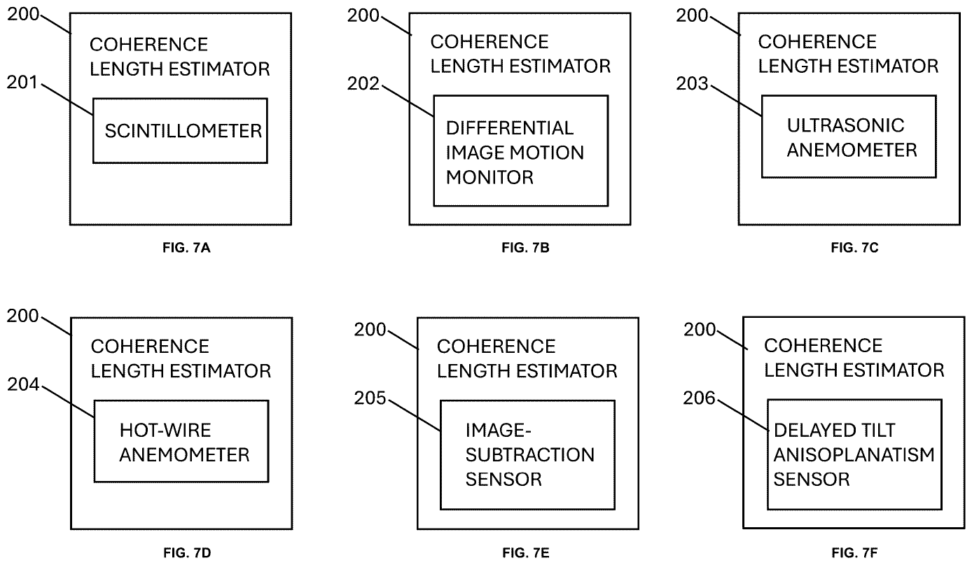

Optionally, the apparatus 10 further includes a standard coherence length estimator 200 generating coherence length data, as shown by way of illustration in FIG. 2. In an embodiment of the invention, the coherence length estimator is an apparatus or method for estimating the average atmospheric turbulence-induced optical coherence length ro. In an embodiment of the invention, the convolutional neural network 60 receives the coherence length data and outputs control data to the wavefront corrector 30 based in part on the coherence length data. In an embodiment of the invention, the position of the pre-focus camera 54 and/or the post-focus camera 56 are adjusted in part based on the coherence length data. In an embodiment of the invention, the focal length of the zoom lens or plurality of zoom lenses discussed below are adjusted in part based on the coherence length data. Optionally, the coherence length estimator 200 includes a standard scintillometer 201, a standard differential image motion monitor 202, a standard ultrasonic anemometer 203, a standard hot-wire anemometer 204, a standard image-subtraction sensor 205, and/or a standard delayed tilt anisoplanatism sensor 206, such as shown by way of illustration in FIGS. 7A-7F.

Optionally, in another embodiment of the invention, the lens 140 comprises a focal plane and a focal length. In this embodiment of the invention, the laser comprises a central wavelength, the focal plane camera 52 is located at the focal plane of the lens, and the pre-focus camera 54 and/or the post-focus camera 56 is located a distance from the focal plane of the lens, the distance being a Rayleigh range for the scattered light from the distorted spot. In an embodiment of the

invention, the distance is

$${z}_{R} = \frac{πλ}{4} {( \frac{{f}_{obj}}{{r}_{0 eff}} )}^{2} ,$$

where Z_{R} is an estimate of the Rayleigh range for the distorted light scattered from the distorted spot, f_{obj} is the focal length of the lens respectively corresponding to the pre-focus camera 54 and/or the post-focus camera 56, λ is the central wavelength of the laser light emitted by the laser, and r_{0 eff} is the coherence length of the turbulence (e.g., a Fried parameter) measured by the coherence length estimator, scaled to account for any magnification between the atmosphere and the lens 140. In an embodiment of the invention, the apparatus 10 further includes standard actuators (e.g., at least one motor, software, and/or at least one control system) adjusting the positions of the pre-focus camera 54 and/or the post-focus camera 56 in order to maintain said distance according to time-varying measurements of r_{0 eff} produced by the coherence length estimator.

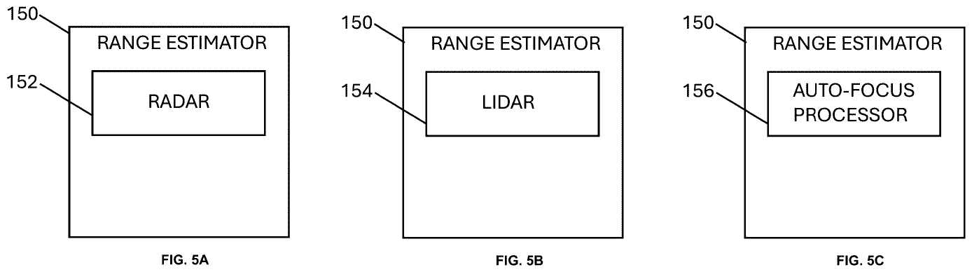

Optionally, the apparatus 10 further includes a range estimator 150 generating range data, as shown by way of illustration in FIG. 2. For the purpose of this patent application, “range estimator” is a defined term and means an apparatus or method for estimating range to an object in the presence of atmospheric optical turbulence and accounting for such presence in the estimated range. The range data include a distance between the range estimator 150 and the scattering object 40. The convolutional neural network 60 receives the range data. The convolutional neural network 60 outputs control data to the wavefront corrector 30 based in part on the range data. Optionally, the range estimator 150 includes a standard RADAR 152, a standard LIDAR 154, and/or a standard auto-focus processor 156, as shown by way of illustration in FIGS. 5A-5C. In an embodiment of the invention, the auto-focus processor 156 includes a standard processor executing a standard auto-focus algorithm. In an embodiment of the invention, the auto-focus algorithm includes a standard Depth from Defocus (“DFD”) algorithm, wherein a defocus distance is estimated from a single image or a few defocused images. In another embodiment of the invention, the auto-focus algorithm includes a standard Depth from Focus (“DFF”)/Contrast Detection algorithm, wherein the DFD estimate is used as a starting point for a standard iterative search method, e.g., a hill-climbing algorithm.

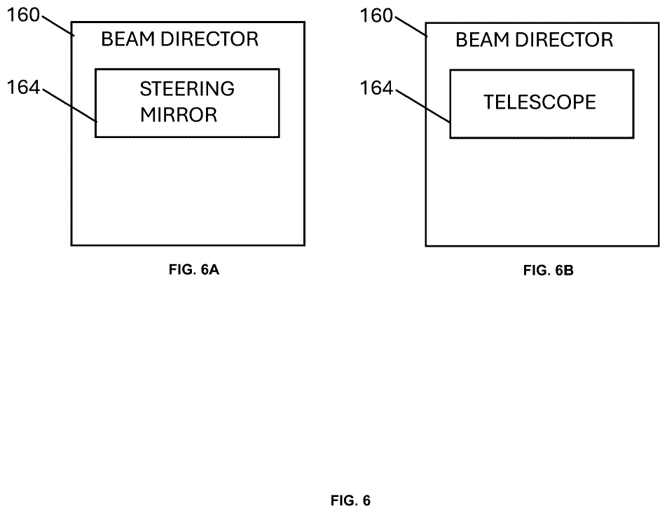

Optionally, the apparatus 10 further includes a standard beam director 160 optically positioned between the wavefront corrector 30 and the distorting optical medium, as shown by way of illustration in FIG. 2. Optionally, the beam director 160 includes a standard steering mirror 162 and/or a standard telescope 164, as shown by way of illustration in FIGS. 6A and 6B. Optionally, the plurality of imaging cameras 50 includes an optical axis. The apparatus further includes a standard dichroic mirror 170 optically positioned between the wavefront corrector 30 and the plurality of imaging cameras, as shown by way of illustration in FIG. 2. The apparatus further includes a standard track camera 180 cooperating with the laser 20 and the plurality of imaging cameras 50 so that the laser and the optical axis point at the scattering object 40. The dichroic mirror 170 receives tracking light from the scattering object 40. The tracking light includes ambient light scattered from the scattering object 40, illuminator light scattered from the scattering object, and/or object light emitted from the scattering object. In an embodiment of the invention, the track camera 180 includes a wide-angle view which can encompass the whole extent of the scattering object. The track camera 180 includes wavelength filtering, time gating, or some other standard way to make sure that the track camera does not see the laser light. Instead, the track camera 180 uses ambient light (e.g., sunlight, if it is daytime), object light (e.g., if the scattering object is itself glowing), or illuminator light (e.g., if the platform on which an embodiment of the invention is installed includes an illuminator laser). The dichroic mirror 170 directs the scattered laser light to the lens 140. The dichroic mirror 170 directs the tracking light to the track camera 180. The track camera 180 generates tracking data based on the tracking light. The apparatus 10 further includes a standard tracking controller 190 receiving tracking data generated by the track camera 180. The tracking controller 190 controls, based on the tracking data, the motion of the beam director 160 so as to direct the laser light to the scattering object 40.

In an embodiment of the invention, the plurality of cameras 50 respectively cooperates with standard wavelength-sensitive filters in front of them so that they only see the wavelength, or wavelengths, of the laser light. In an embodiment of the invention, the plurality of imaging cameras 50 includes a narrow-angle view so that they only image the region immediately surrounding the laser spot.

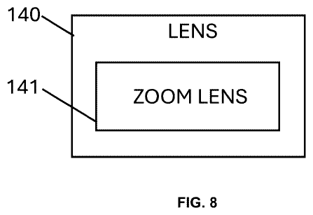

Optionally, the lens 140 includes a zoom lens 141, i.e., a lens having an adjustable focal length, as shown by way of illustration in FIG. 8. The laser light includes a central wavelength. The zoom lens 141 includes an adjustable focal length. The zoom lens 141 optically cooperates with the plurality of imaging cameras 50. The wavefront corrector 30 directs the scattered light from the distorted spot to the zoom lens 141. The zoom lens 141 focuses the scattered light from the distorted spot onto the plurality of imaging cameras. The adjustable focal length corresponding to the central wavelength and the coherence length data. The plurality of imaging cameras 50 form distorted images of the distorted laser spot on the scattering object 50. In embodiments of the invention where lens 140 includes a plurality of lenses, one or more of the lenses may include zoom lenses.

In an embodiment of the invention, the zoom lens 140 further includes an adjustable focal plane. In this embodiment of the invention, the focal plane camera 52 is located at the focal plane of the zoom lens, and the pre-focus camera 54 and/or the post-focus camera 56 is located a distance from the focal plane of the zoom lens 140, the distance being half the adjustable focal length of the lens. In embodiments of the invention where zoom lens 140 includes a plurality of zoom lenses, the adjustable focal lengths of the several zoom lenses may be the same or different from one another. In these embodiments, the distance from the adjustable focal plane for the pre-focus camera 54 and/or the post-focus camera 56 is half the adjustable focal length of the zoom lens respectively corresponding to that camera. In an embodiment of the invention, the apparatus 10 further includes standard actuators (e.g., at least one motor, software, and/or at least one control system) adjusting the positions of the focal plane camera 52, pre-focus camera 54, and/or the post-focus camera 56 in order to maintain said location at the adjustable focal plane and/or said distance according to variations in the adjustable focal plane and/or adjustable focal length of said zoom lens.

In another embodiment of the invention, the zoom lens 140 further includes an adjustable focal plane. In this embodiment of the invention, the laser includes a central wavelength, the focal plane camera 52 is located at the adjustable focal plane of the zoom lens, and the pre-focus camera 54 and/or the post-focus camera 56 is located a distance from the adjustable focal plane of the zoom lens, the distance being a Rayleigh range for the scattered light from the distorted spot. In an embodiment of the invention, the distance is

$${z}_{R} = \frac{πλ}{4} {( \frac{{f}_{obj}}{{r}_{0 eff}} )}^{2} ,$$

where Z_{R} is an estimate of the Rayleigh range for the distorted light scattered from the distorted spot, f_{obj} is the adjustable focal length of the zoom lens respectively corresponding to the pre-focus camera 54 and/or the post-focus camera 56, λ is the central wavelength of the laser light emitted by the laser, and r_{0 eff} is the coherence length of the turbulence (e.g., a Fried parameter) measured by the coherence length estimator, scaled to account for any magnification between the atmosphere and the zoom lens 140. In an embodiment of the invention, the apparatus 10 further includes standard actuators (e.g., at least one motor, software, and/or at least one control system) adjusting the positions of the focal plane camera 52, pre-focus camera 54, and/or the post-focus camera 56 in order to maintain said location at the adjustable focal plane and/or said distance according to variations in the adjustable focal plane and/or adjustable focal length of said zoom lens, and/or according to time-varying measurements of r_{0 eff} produced by the coherence length estimator.

In an embodiment of the invention, the apparatus 10 further includes standard actuators (e.g., a motor, software, and/or control system, or plurality thereof) adjusting the focal length of the zoom lens and/or zoom lenses according to the equation where

$${f}_{obj} = \frac{{( 2 r )}_{0 eff}^{2}}{πλ} ,$$

f_{obj} is the focal length of the zoom lens, λ is the central wavelength of the laser light emitted by said laser, and r_{0 eff} is the coherence length of the turbulence (Fried parameter) measured by said coherence length estimators, scaled to account for any magnification between the atmosphere and the zoom lens. In an embodiment of the invention, light going to the zoom lens then goes through a plurality of beam splitters, the plurality of beam splitters respectively corresponding to the plurality of cameras. In such an embodiment of the invention, the beam splitters are chosen so as to avoid introducing astigmatism. In another embodiment of the invention, the zoom lens includes a plurality of zoom lenses respectively corresponding to the plurality of cameras. This equation for the optionally adjustable focal length yields a value which is approximately twice the Rayleigh range for the scattered light from the distorted spot.

Optionally, the convolutional neural network 60 receives the coherence length data. In this embodiment of the invention, the convolutional neural network 60 outputs control data to the wavefront corrector 30 based in part on the coherence length data.

Optionally, the apparatus 10 further includes a plurality of beam reflectors 210 respectively optically positioned between the wavefront corrector 20 and the plurality of imaging cameras 50, such as shown by way of illustration in FIG. 9. In an embodiment of the invention, the plurality of beam reflectors 210 are selected to avoid introducing astigmatism when used in light fields that are not collimated. In an embodiment of the invention, the plurality of beam reflectors 210 are selected to send more light to the pre-focus camera 54 and/or the post-focus camera 56 than to the focal plane camera 52. This could account for the increased concentration of light on the focal plane camera 52 relative to the pre-focus camera 54 and/or the post-focus camera 56. In another embodiment of the invention, the plurality of beam reflectors send an equal amount of light to each of the plurality of imaging cameras 50. Optionally, the plurality of beam reflectors 200 includes a 33% beam reflector 214 optically cooperating with the pre-focus camera 54, a 50% beam reflector 212 optically cooperating with the focal plane camera 52, and a 100% beam reflector 216 optically cooperating with the post-focus camera 56, such as shown by way of illustration in FIG. 10. These ratios result in an equal amount of light reaching each of the three cameras. In another embodiment of the invention, the plurality of beam reflectors 200 includes a 33% beam reflector 214 optically cooperating with the pre-focus camera 54 via lens 144, a 50% beam reflector 212 optically cooperating with the focal plane camera 52 via lens 142, and a 100% beam reflector 216 optically cooperating with the post-focus camera 56 via lens 146, such as shown by way of illustration in FIG. 11.

Optionally, the convolutional neural network 60 includes a trained convolutional neural network. The trained convolutional neural network corresponding the image data to the control data. Optionally, the trained convolutional neural network corresponds the range data to the control data.

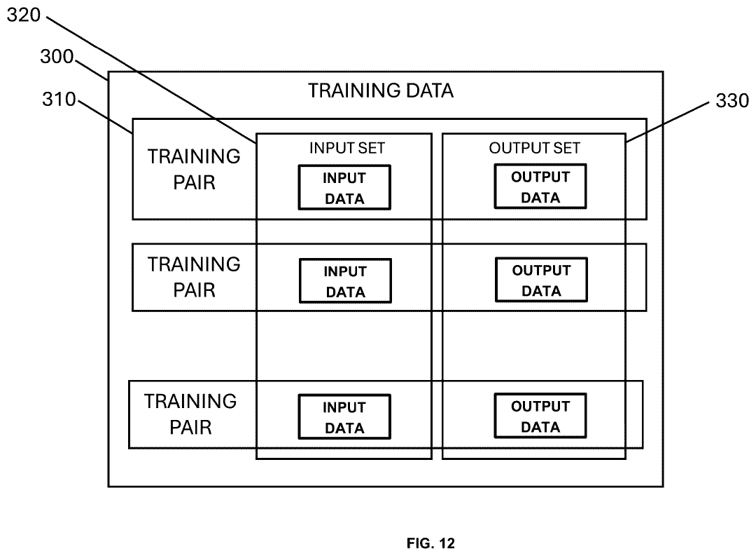

TRAINING DATA IN GENERAL. In an embodiment of the invention, before system deployment, training data 300 is gathered, such as shown by way of illustration in FIG. 12. For the purpose of this patent application, “training data” is a term of art and includes a plurality of training pairs 310. For the purpose of this patent application, “training pair” is a term of art, and each training pair includes an input data and an output data. Each input data includes at least image data. Optionally, each input data further includes range data and/or coherence length data. The set of the plurality of input data is termed the “input set” 320. Each output data includes at least control data. The set of the plurality of output data is termed the “output set” 330. It will be readily appreciated by those of ordinary skill in the art that analogous data sets with analogous structure are formed by replacing “training” with “evaluation” or some other word denoting the use to which the data is put. For ease of illustration, only three training pairs 310 are shown in FIG. 12. An embodiment of the invention includes less than three training pairs. Another embodiment of the invention includes more than three training pairs.

GATHERING SIMULATED TRAINING DATA. In an embodiment of the invention, training data 300 is gathered using computer simulations. In such an embodiment, a standard laser propagation code is used to generate input data and output data. Examples of standard laser propagation codes include the LightPipes MATLAB toolbox, the LightPipes Python library, the AOtools Python library (such as described in TOWNSON, M. J., et al., “AOtools: a Python package for adaptive optics modelling and analysis,” Optics Express, 28 Oct. 2019, pp. 31316-31329, Vol. 27, No. 22, Optica Publishing Group, Washington, DC, USA, which is incorporated herein by reference), and/or the Naval Research Laboratory's Python Code for Atmospheric Propagation (“PyCAP”).

In such an embodiment of the invention, the laser propagation code generates input data by simulating at least the following: laser propagation through a distorting optical medium, formation of a distorted spot on a scattering object, scattering of the light from the distorted spot, propagation of the scattered light back through the distorting optical medium, and detection of the scattered light using the imaging cameras 50 to produce image data. The input data includes the image data. Optionally, the simulation further produces range data and/or coherence length data, and the input data further includes the range data and/or said coherence length data. It will be readily appreciated by one of ordinary skill in the art that in performing such a simulation, the range of propagation and coherence length are parameters which may be freely selected.

In such an embodiment of the invention, the laser propagation code further generates output data. In an embodiment of the invention, the laser propagation code generates the output data by simulating the propagation of a cooperative beacon laser from the scattering object, through the distorting optical medium, to the wavefront corrector. One of ordinary skill in the art will readily appreciate the properties desired of such a cooperative beacon laser: that its wavelength is approximately equal to that of the laser 20, that its spot size at the scattering object is equal to or smaller than the diffraction-limited spot that would be formed on the scattering object by the laser light from laser 20 in the absence of turbulence, that its wavefront at the scattering object be flat, and so on. At the wavefront corrector, the wavefront of the beacon laser is read out. In such an embodiment of the invention, the control data includes an equal and opposite adjustment to the wavefront. In another embodiment of the invention, the laser propagation code generates the output data by holding the simulated distorting optical medium fixed, performing random or semi-random variations on the simulated WFC, observing the resulting beam spot on the scattering object, scoring the spot according to a user-determined figure of merit, and using standard “variational,” “iterative,” or “hill-climbing” techniques (such as stochastic parallel gradient descent) to arrive at a WFC adjustment which maximizes or satisfices the figure of merit. Because the simulated environment allows the distorting optical medium (which is typically time-varying) to be held constant, the iterative techniques (often too slow for application in real-time) become practical. In such an embodiment of the invention, the control data includes the adjustment.

In such an embodiment of the invention, the above-mentioned computer simulations include the effects of one or more of the optional elements, recited above, which are included in the user's adaptive optics apparatus 10. For instance, if the embodiment of the invention includes a track camera 140, a track controller 190, and a beam director 160, then the computer simulations include the effect of these elements. For example, the laser and the optical axis of the plurality of imaging cameras are directed at the scattering object.

In such an embodiment of the invention, the computer simulations are performed in order to build up a plurality of training pairs. The training data includes the plurality of training pairs.

In such an embodiment of the invention, the above-mentioned computer simulations are performed with range and coherence length chosen so as to match the user's intended purpose for the adaptive optics apparatus 10. For instance, if the user intends to operate the adaptive optics apparatus at ranges between 1 and 10 km, in a distorting optical medium with coherence lengths between 5 mm and 100 mm, then the above-mentioned computer simulations are performed with range varying between 1 and 10 km, and coherence length varying between 5 mm and 100 mm.

GATHERING EXPERIMENTAL TRAINING DATA. In another embodiment of the invention, training data 300 is gathered using experiments performed in a controlled environment. In such an embodiment, input data and output data are the measured outcomes of the experiment.

In such an embodiment of the invention, the experimental apparatus includes the optional elements, recited above, which are to be included in the final system. For instance, if the embodiment of the invention includes a track camera 140, a track controller 190, and a beam director 160, controlled so as to direct the laser light to the scattering object, then said experiment includes said elements performing said function.

In such an embodiment of the invention, said experiment produces input data in the following manner: a laser emits laser light, said laser light propagating through a distorting optical medium and forming a distorted spot on a scattering object, said scattering object scattering said laser light from the distorted spot, said scattered light propagating back through said distorting optical medium, said scattered light forming images on said imaging cameras, said imaging cameras producing image data. The input data includes the image data. Optionally, said experiment further includes a range estimator generating range data and/or a coherence length estimator generating coherence length data, and said input data further includes said range data and/or said coherence length data.

In such an embodiment of the invention, said experiment further generates output data. In one embodiment said experiment generates said output data by locating a cooperative beacon, such as a laser or similar cooperative light source, at the object plane, and propagating a cooperative beacon beam from the scattering object, through the distorting optical medium, to the wavefront corrector. Because the experiment is performed in a controlled environment, a cooperative beacon (which may not be available in deployment) is easily installed. At the wavefront corrector the phase of the beacon may be detected using standard wavefront sensing techniques known in the art, such as a Shack-Hartmann wavefront sensor, pyramid wavefront sensor, and/or digital holographic wavefront sensor. In such an embodiment the control data includes an equal and opposite adjustment to said wavefront. In another embodiment, said experiment generates said output data by choosing a distorting optical medium which varies slowly in time or can be made to do so, such as a plurality of phase plates and/or a plurality of deformable mirrors and/or a plurality of spatial light modulators and/or a fluid cell containing a slow-moving turbulent fluid. Said experiment thereafter performing random or semi-random variations on the WFC, observing the resulting beam spot on the scattering object, scoring said spot according to some figure of merit, and using standard “variational,” “iterative,” or “hill-climbing” techniques (such as stochastic parallel gradient descent) to arrive at a WFC adjustment which maximizes or satisfices the figure of merit. Because the experiment has been designed to use a distorting optical medium which varies slowly or not at all, said iterative techniques (too slow for application in real-time) become practical. In such an embodiment the control data includes said adjustment.

In such an embodiment of the invention, a plurality of said experiments are performed in order to build up a plurality of training pairs. The training data comprises said plurality of training pairs.

In an embodiment of the invention, the above-mentioned experiments are performed with range and coherence length chosen so as to match the user's intended purpose for the adaptive optics apparatus 10. For instance, if the user intends to operate the adaptive optics apparatus at ranges between 500 meters and 2500 meters, in a distorting optical medium with coherence lengths between 5 mm and 100 mm, then the above-mentioned experiments are performed with range varying between 500 meters and 2500 meters, and coherence length varying between 5 mm and 100 mm. In another embodiment of the invention, the above-mentioned experiments are performed with scaled range and coherence length chosen so as to match the user's intended purpose for the adaptive optics apparatus 10. For instance, if the user intends to operate an adaptive optics apparatus with an initial beam diameter of 100 mm, at ranges between 500 meters and 2500 meters, in a distorting optical medium with coherence lengths between 5 mm and 100 mm, then the above-mentioned experiments may be performed instead with an initial beam diameter of 10 mm, with range varying between 50 meters and 250 meters, and coherence length varying between 0.5 mm and 10 mm.

STRUCTURE OF THE CNN. In an embodiment of the invention, the structure of CNN 60 matches the elements of the adaptive optics system 10 that cooperate with the CNN. For example, if the adaptive optics apparatus 10 includes a range estimator, the CNN structure accommodates input data for the CNN 60 including range data. Similarly, if the adaptive optics apparatus 10 includes a focal plane camera and a pre-focus camera, but not a post-focus camera, the CNN structure accommodates input data that includes image data from the focal plane camera and the pre-focus camera, but not from the post-focus camera.

TRAINING THE CNN. In an embodiment of the invention, the CNN 60 is trained to perform standard image regression. In an embodiment of the invention, the CNN 60 is trained using the training data using standard machine learning techniques, comprising supervised learning. In an embodiment of the invention, the weights and biases of the CNN 60 are randomly initialized. The CNN is driven with said plurality of input data, e.g., image data, range data, and/or coherence length data. The CNN's output is compared to the plurality of output data, e.g., control data. Standard machine learning algorithms, e.g., back-propagation and/or Adaptive Moment Estimation (“Adam”), are used to update the CNN's parameters, thereby reducing output error. This process is iterated to satisfice CNN performance.

An example of CNN training and evaluation, consistent with an embodiment of the invention, is provided in U.S. Provisional Patent Application No. 63/760,773 filed 20 Feb. 2025, which as mentioned above is incorporated herein by reference. An example of CNN training and evaluation, consistent with an embodiment of the invention, is provided in DICOMO, G. P., et al., “Beaconless adaptive optics for atmospheric laser propagation with multi-plane convolutional neural network,” Optics Express, 28 Jul. 2025, pp. 31010-31028, Vol. 33, No. 15, Optica Publishing Group, Washington, DC, USA, which is incorporated herein by reference. The CNN 60 is trained to correlate initial, uncorrected image data with control data comprising a desired WFC setting.

RESULTS AFTER SUCH TRAINING. After such training, the laser 20 emits laser light, which passes through a distorting optical medium to a scattering object. The plurality of imaging cameras 50 captures image data, which includes aberrated images of the aberrated beam spot on the scattering object. This image data, optionally together with range data and/or coherence length data, is fed into the CNN 60. Having already correlated similar image data, and optionally range data and/or coherence length data, to appropriate control data during training, the trained CNN 60 predicts the correct WFC setting in a single pass. The control data includes this predicted correct WFC setting. The control data is sent from the CNN 60 to the WFC 30, which applies the appropriate WFC setting. Subsequently, when the laser 20 emits laser light, the WFC 30 reflects a corrected beam to the scattering object. The corrected beam is thereby pre-compensated for phase distortions caused by the distorting optical medium. That is, in an embodiment of the invention, after training, the CNN 60 uses actual (i.e., real) image data from the scattering object 40 (and optionally range data and/or coherence length data) to produce an accurate estimate of the wavefront correction to be applied. The CNN 60 uses this accurate estimate of the wavefront correction to generate accurate control data for the WFC 30.

An embodiment of the invention is not a conventional wavefront sensor and does not perform wavefront sensing as conventionally understood. Conventional systems and methods sense the wavefront of scattered light which forms the image data; the wavefront of that scattered light is corrupted by the shape and roughness of the scattering object. Sensing and correcting for the wavefront distortions due to the shape and roughness of the scattering object is not desirable, and does not result in the best laser propagation and/or imaging of the scattering object and/or figure of merit on the scattering object. By contrast, in an embodiment of the invention, only those wavefront distortions which are due to the distorting optical medium are to be corrected. Further, in the presence of a distorting optical medium, the spot produced by a laser on the scattering object forms an extended spot which does not meet the criteria for a small beacon spot; the wavefront of the scattered light from that spot will therefore be corrupted by anisoplanatism error. Sensing and correcting the wavefront of light scattered from an extended spot is not desirable, and does not result in the best laser propagation and/or imaging of the scattering object and/or figure of merit on the scattering object. Only in the case where a small light source, free of substantial phase noise due to roughness, is present near the object of interest will wavefront sensing approaches produce the desired correction. Therefore, a correction equal and opposite to the wavefront of the light scattered from the laser spot on the scattering object is not actually the desired correction.

By contrast, in an embodiment of the invention, CNN 60 associates input data (which includes image data and optionally range data and/or coherence length data), with corresponding output data (which includes control data). In this embodiment of the invention, the control data does not represent the wavefront of the scattered light which formed the image data, or indeed the wavefront of any light which is physically present. Rather, in this embodiment of the invention, the control data represents a desired wavefront correction which results in improved laser propagation and/or improved imaging of the scattering object and/or improved figure of merit on the scattering object.

In an embodiment of the invention wherein the CNN 60 is trained using a cooperative beacon laser in experiment and/or simulation, the control data represents the (equal and opposite) predicted wavefront that such a cooperative beacon would produce at the location of the WFC 30, were such a cooperative beacon physically present at the scattering object. In an embodiment of the invention wherein the CNN 60 is trained using iterative techniques in experiment and/or simulation, the control data represents the predicted adjustment that would be arrived at using the iterative techniques, were such techniques to be employed. Because the CNN 60 is a feedforward neural network, it executes in a single forward pass, without either computational iteration (as in Crepp et al) or physical iteration (as in beaconless variational AO techniques). CNN 60 thereby skips the intervening steps of actually performing the iteration, producing the same predicted result in an instant.

Optionally, one or more portions of the invention operate in a standard computing operating environment, for example, a desktop computer, a laptop computer, a mobile computer, a server computer, a field-programmable gate array, an application-specific integrated circuit, and the like. Although the invention is described in the general context of program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, autonomous embedded computers, and the like. The invention may also be practiced in distributed computing environments where tasks are performed by remote processing devices that are linked through a communications network. In a distributed computing environment, program modules may be located in both local and remote memory storage devices.

An illustrative operating environment for embodiments of the invention is described as follows. A computer comprises a general purpose desktop, laptop, handheld, mobile or other type of computer (computing device) capable of executing one or more application programs. The computer includes at least one graphics processing unit (“GPU”), at least one central processing unit (“CPU”), a system memory, including a random access memory (“RAM”) a read-only memory (“ROM”), and/or a system bus that couples the memory to the CPU. A basic input/output system containing the basic routines that help to transfer information between elements within the computer, such as during startup, is stored in the ROM. The computer further includes a mass storage device for storing an operating system, application programs, and other program modules.

The mass storage device is connected to the CPU through a mass storage controller connected to the bus. The mass storage device and its associated computer-readable media provide non-volatile storage for the computer. Although the description of computer-readable media contained herein refers to a mass storage device, such as a hard disk or CD-ROM drive, it should be appreciated by those skilled in the art that computer-readable media can be any available media that can be accessed or utilized by the computer.

By way of example, and not limitation, computer-readable media comprise computer storage media and communication media. Computer storage media includes non-transitory, non-volatile, removable and non-removable media implemented in any method or technology for storage of information such as computer-readable instructions, data structures, program modules or other data. Such non-transitory computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other tangible non-transitory medium which can be used to store the desired information and which can be accessed by the computer.

According to various embodiments of the invention, the computer may operate in a networked environment using logical connections to remote computers through a network, such as a local network, the Internet, etc. for example. The computer may connect to the network through a network interface unit connected to the bus. It should be appreciated that the network interface unit may also be utilized to connect to other types of networks and remote computing systems.

The computer optionally also include an input/output controller for receiving and processing input from a number of other devices, including a keyboard, mouse, sensor, load cell, transducer, etc. Similarly, an input/output controller may provide output to a display screen, a printer, or other type of output device.

As mentioned briefly above, a number of program modules and data files may be stored in the mass storage device and RAM of the computer, including an operating system suitable for controlling the operation of a networked personal computer. The mass storage device and RAM may also store one or more program modules. In particular, the mass storage device and the RAM may store application programs, such as a software application, for example, a word processing application, a spreadsheet application, a slide presentation application, a database application, etc.

It should be appreciated that various embodiments of the instant invention may be implemented as a sequence of computer-implemented acts or program modules running on a computing system and/or as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the instant invention as described herein.

Although a particular feature of the disclosure may have been illustrated and/or described with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

As used herein, the singular forms “a”, “an,” and “the” do not preclude plural referents, unless the content clearly dictates otherwise.

As used herein, the term “and/or” includes any and all combinations of one or more of the associated listed items.

As used herein, the term “about” when used in conjunction with a stated numerical value or range denotes somewhat more or somewhat less than the stated value or range, to within a range of ±10% of that stated.

All documents mentioned herein are hereby incorporated by reference for the purpose of disclosing and describing the particular materials and methodologies for which the document was cited.

Although the instant invention has been described in connection with preferred embodiments thereof, it will be appreciated by those skilled in the art that additions, deletions, modifications, and substitutions not specifically described may be made without departing from the spirit and scope of the invention. Terminology used herein should not be construed as being “means-plus-function” language unless the term “means” is expressly used in association therewith.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

These and other implementations are within the scope of the following claims.

What is claimed is:

1. An apparatus comprising:
a laser emitting laser light;
a wavefront corrector, said wavefront corrector directing the laser light through a distorting optical medium to a scattering object, the distorted light forming a distorted spot on the scattering object, the scattering object scattering the distorted light from the distorted spot back through the distorting optical medium, the scattered light from the distorted spot impinging upon said wavefront corrector;
a plurality of imaging cameras comprising a focal plane camera and at least one of a post-focus camera and a pre-focus camera, said plurality of imaging cameras receiving the scattered light from the distorted spot via said wavefront corrector, said plurality of imaging cameras generating image data; and
a convolutional neural network receiving at least the image data, said convolutional neural network outputting control data to said wavefront corrector based in part on the image data, the control data adjusting said wavefront corrector to correct for distortions imposed by the distorting optical medium.

2. The apparatus according to claim 1, further comprising:
an optical switch directing the laser light to said wavefront corrector.

3. The apparatus according to claim 2, wherein the optical switch comprises at least one of:
a polarizing beam splitter and one of: a quarter-wave plate optically cooperating with said polarizing beam splitter, a Faraday rotator optically cooperating with said polarizing beam splitter, and a Pockels cell optically cooperating with said polarizing beam splitter;
a MEMS optical switch;
an acousto-optic deflector; and
a diffraction grating and an acousto-optic modulator optically cooperating with said diffraction grating.

4. The apparatus according to claim 1, further comprising:
a lens optically cooperating with said plurality of imaging cameras, said wavefront corrector directing the scattered light from the distorted spot to said lens, said lens focusing the scattered light from the distorted spot onto said plurality of imaging cameras.

5. The apparatus according to claim 4, wherein said lens comprises a focal plane, said lens comprising a focal length,
wherein the focal plane camera is located at the focal plane of said lens,
wherein the at least one of a post-focus camera and a pre-focus camera is located a distance from the focal plane of the lens, the distance being half the focal length of the lens.

6. The apparatus according to claim 4, wherein said lens comprises a focal plane, said lens comprising a focal length,
wherein the focal plane camera is located at the focal plane of said lens,
wherein the at least one of a post-focus camera and a pre-focus camera is located a distance from the focal plane of the lens, the distance being a Rayleigh range for the scattered light from the distorted spot.

7. The apparatus according to claim 1, further comprising:
a range estimator generating range data, the range data comprising a distance between said range estimator and the scattering object, said convolutional neural network receiving the range data, said convolutional neural network outputting control data to said wavefront corrector based in part on the range data.

8. The apparatus according to claim 7, wherein said range estimator comprises at least one of:
a RADAR,
a LIDAR, and
an auto-focus processor.

9. The apparatus according to claim 1, further comprising:
a beam director optically positioned between said wavefront corrector and the distorting optical medium.

10. The apparatus according to claim 9, wherein said beam director comprises at least one of:
a steering mirror; and
a telescope.

11. The apparatus according to claim 9, wherein said plurality of imaging cameras comprise an optical axis,
wherein the apparatus further comprises:
a dichroic mirror optically positioned between said wavefront corrector and said plurality of imaging cameras; and
a track camera cooperating with said laser and said plurality of imaging cameras so that said laser and the optical axis point at the scattering object, said dichroic mirror receiving tracking light from the scattering object, the tracking light comprising at least one of: ambient light scattered from the scattering object, illuminator light scattered from the scattering object, and object light emitted from the scattering object; said dichroic mirror directing the scattered light to the plurality of lenses; said dichroic mirror directing the tracking light to the track camera, said track camera generating tracking data based on the tracking light; and
a tracking controller receiving tracking data generated by the track camera, said tracking controller controlling, based on the tracking data, the motion of said beam director so as to direct the laser light to the scattering object.

12. The apparatus according to claim 4, further comprising:
a coherence length estimator generating coherence length data.

13. The apparatus according to claim 12, wherein said coherence length estimator comprises at least one of:
a scintillometer;
a differential image motion monitor;
an ultrasonic anemometer;
a hot-wire anemometer;
an image-subtraction sensor, and
a delayed tilt anisoplanatism sensor.

14. The apparatus according to claim 12, wherein said lens comprises a zoom lens,
wherein the laser light comprises a central wavelength,
wherein said zoom lens comprises an adjustable focal length, said zoom lens optically cooperating with said plurality of imaging cameras, said wavefront corrector directing the scattered light from the distorted spot to said zoom lens, said zoom lens focusing the scattered light from the distorted spot onto said plurality of imaging cameras; and
said adjustable focal length corresponding to said central wavelength and said coherence length data.

15. The apparatus according to claim 14, wherein said adjustable focal length is twice the Rayleigh range for the scattered light from the distorted spot.

16. The apparatus according to claim 12, wherein said convolutional neural network receives the coherence length data, said convolutional neural network outputting control data to said wavefront corrector based in part on the coherence length data.

17. The apparatus according to claim 1, further comprising:
a plurality of beam reflectors respectively optically positioned between said wavefront corrector and said plurality of imaging cameras.

18. The apparatus according to claim 17, wherein said plurality of beam reflectors comprises:
a 33% beam reflector optically cooperating with said pre-focus camera,
a 50% beam reflector optically cooperating with said focal plane camera, and
a 100% beam reflector optically cooperating with said post-focus camera.

19. The apparatus according to claim 7, wherein said convolutional neural network comprises a trained convolutional neural network, said trained convolutional neural network corresponding the image data to the control data.

20. The apparatus according to claim 19, wherein said trained convolutional neural network corresponds the range data to the control data.
